(19) United States
(12) Patent Application Publication
(10) Pub. No.: US 2024/0073645 A1
(43) Pub. Date: Feb. 29, 2024

(54) CONTROL OF WIRELESS CONNECTIVITY VIA DIFFERENT WIRELESS TECHNOLOGIES/NETWORKS

(71) Applicant: Charter Communications Operating, LLC., St. Louis, MO (US)

(72) Inventors: Hossam H. Hmimy, Aurora, CO (US); Hany A. Heikal, Aurora, CO (US); Mohamed Daoud, Englewood, CO (US)

(21) Appl. No.: 17/897,486

(22) Filed: Aug. 29, 2022

(51) Int. Cl. H04W 4/029; H04W 48/18; H04W 76/10

(52) U.S. Cl. CPC H04W 4/029; H04W 48/18; H04W 76/10

(57) ABSTRACT

Via generation of tracking information, a management resource tracks availability of multiple types of wireless technologies at multiple geographical regions in a network environment. The communication management resource receives a current location of a first vehicle and uses the current location to determine that the first vehicle resides within a first geographical region of the multiple geographical regions. The communication management resource then uses the tracking information to determine multiple types of wireless technologies supported at the current location in which the first vehicle resides. The communication management resource then selects amongst the multiple types of wireless technologies to establish wireless connectivity between the first vehicle and the remote network.

### BACKGROUND

The continuing evolution of automotive technology aims to deliver greater safety benefits and automated driving systems (ADS) that, one day, can handle all driving tasks without human vehicle drivers. To achieve a fully automated safety feature and highway autopilot, a respective vehicle typically needs to support communications with a remote management resource. Preferably, latency between the vehicle and a remote controller resource is minimal.

In a communication system, the latency is the time it takes to transfer data from one location to another. Wireless technology typically offers an extremely low latency (or delay) between a time that data is sent and a time of receiving that data at a destination. Typically, the latency of a wireless network may be from 200 milliseconds for 4G wireless technology and even lower such as 1 millisecond (1 ms) via 5G wireless technology.

One application of wireless technology is vehicular control. For example, a vehicle can be configured to establish connectivity with a remote management resource over a wireless communication link. In such an instance, the vehicle provides information such as its location, speed, etc., over the wireless communication link to the remote management resource. The remote management resource processes the received data and provides control commands back to the vehicle based on provided information.

Several different networks may be available to provide a vehicle connectivity to the remote management resource.

### BRIEF DESCRIPTION OF EMBODIMENTS

In order to have a fully automated driving system, vehicles and trucks may be continuously in communication with each other and a remote management resource. Typically, 4G/5G mobile networks will be the main means of communication for that task. A problem arises in remote areas where there is no coverage. In order to address this problem, satellite communication may be able to provide wireless connectivity to a remote management resource. But again, the satellite communication technology is limited by the amount of bandwidth/area if many vehicles are within one remote area. These vehicles/trucks will easily consume all the bandwidth.

Embodiments herein provide improved implementation of wireless access networks and expand use of limited wireless bandwidth in a network environment.

More specifically, via generation of tracking information, a management resource (one or more management entities) tracks availability of multiple types of wireless technologies at multiple geographical regions in a network environment. The communication management resource receives a current location of a first vehicle and uses the current location to determine that the first vehicle resides within a first geographical region of the multiple geographical regions. The communication management resource then uses the tracking information to determine multiple types of wireless technologies supported at the current location in which the first vehicle resides. The communication management resource then selects amongst the multiple types of wireless technologies to establish wireless connectivity between the first vehicle and the remote network.

In one embodiment, the tracking information indicates prior use of the multiple types of wireless technologies by multiple vehicles other than the first vehicle.

In further example embodiments, the management hardware determines a performance of the multiple types of wireless technologies supported at the current location based on input from a communication device in the first vehicle, the input including a performance analysis of wireless communications between the communication device in the first vehicle and multiple wireless networks supporting the multiple types of wireless technologies.

In still further example embodiments, tracking availability of the multiple types of wireless technologies at the different geographical regions in the network environment via the tracking information includes the management hardware receiving feedback from multiple vehicles other than the first vehicle traveling through the different geographical regions in the network environment, the feedback indicating the availability of the multiple wireless technologies at the different geographical regions in the network environment.

The multiple types of wireless technologies include one or more of: a first wireless technology supporting wireless connectivity in accordance with a first wireless communication protocol; a second wireless technology supporting wireless connectivity in accordance with a second wireless communication protocol; and a third wireless technology supporting wireless connectivity in accordance with a third wireless communication protocol.

In still further example embodiments, selection amongst the multiple types of wireless technologies to establish connectivity between the first vehicle and the remote network includes: from the multiple types of wireless technologies supported at the current location, via the management hardware, selecting a first wireless technology to support a first wireless communication link between the first vehicle and a first wireless access point providing first access to the remote network; and from the multiple types of wireless technologies supported at the current location, via the communication management hardware, selecting a second wireless technology to support a second wireless communication link between the first vehicle and a second wireless access point providing second access to the remote network.

In yet further example embodiments, the first wireless communication link and the second wireless communication link are simultaneously implemented by a communication device in the first vehicle to support redundant wireless connectivity between the first vehicle and the remote network.

Determination of the multiple types of wireless technologies can be implemented in a similar manner. In one embodiment, the communication management hardware: i) receives input from a communication device in the first vehicle, the input indicating the multiple types of wireless technologies supported at the current location in which the vehicle resides. Selection amongst the multiple types of wireless technologies to establish connectivity between the first vehicle and the remote network includes: via the management hardware or other suitable entity, determining a respective wireless performance associated with each of the multiple types of wireless technologies.

In still further example embodiments, the first vehicle is one of multiple vehicles traveling through the network environment. Selection amongst the multiple types of wireless technologies to establish the wireless connectivity between the first vehicle and the remote network includes: via the management hardware or other suitable entity, providing notification to the first vehicle to establish a wireless communication link through a second vehicle to the remote network.

Embodiments herein are useful over conventional techniques. For example, implementation of a communication management resource and corresponding operations as discussed herein provides better wireless connectivity (such as via lower latency communications) between wireless stations in a wireless network environment.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon. The instructions, when executed by the computer processor hardware, cause the computer processor hardware (such as one or more co-located or disparately processor devices or hardware) to: via tracking information, track availability of multiple different types of wireless technologies available at multiple geographical regions in a network environment; via the tracking information, determine multiple types of wireless technologies supported at a current location in which a first vehicle resides, the current location falling within a first geographical region of the multiple geographical regions; and select amongst the multiple types of wireless technologies to establish wireless connectivity between the first vehicle and the remote network. The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless connectivity in a network environment. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a network environment and corresponding wireless networks providing a communication device simultaneous connectivity to multiple wireless networks according to embodiments herein.

FIG. 2 is an example diagram illustrating a mobile communication device simultaneously in communication with one or more wireless networks according to embodiments herein.

FIG. 3 is an example diagram illustrating details of a mobile communication device and simultaneous access to multiple networks according to embodiments herein.

FIG. 4 is an example diagram illustrating dynamic tracking information indicating availability of wireless networks in different geographical regions according to embodiments herein.

FIG. 5 is an example diagram illustrating detection of multiple different wireless networks in a network environment and testing of same to determine respective connectivity performance according to embodiments herein.

FIG. 6 is an example diagram illustrating generation and comparison of performance information for each of multiple available wireless networks in a given geographical region according to embodiments herein.

FIG. 7 is an example diagram illustrating selection of multiple wireless links and simultaneous use of the selected wireless links to communicate with a remote communication management entity according to embodiments herein.

FIG. 8 is an example diagram illustrating movement of a mobile communication device to and through a second geographical region according to embodiments herein.

FIG. 9 is an example diagram illustrating dynamic tracking information indicating availability of different wireless networks according to embodiments herein.

FIG. 10 is an example diagram illustrating detection of multiple different wireless networks in a network environment and testing of same to determine performance according to embodiments herein.

FIG. 11 is an example diagram illustrating generation and comparison of performance information for each of multiple available wireless networks according to embodiments herein.

FIG. 12 is an example diagram illustrating selection of multiple wireless networks and simultaneous use of the selected wireless networks to communicate with a remote communication management entity according to embodiments herein.

FIG. 13 is an example diagram illustrating example computer hardware and software operable to execute operations according to embodiments herein.

FIG. 14 is an example diagram illustrating a method according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DESCRIPTION OF EMBODIMENTS

It is desirable for (unmanned) self-driving vehicles to connect with a centralized server located on the public internet to provide Real-Time Telematics data such as odometer information, fuel level information, fuel consumption information, location information, speed, environmental/weather conditions, engine diagnostic information, etc. Typically, communications in a vicinity of roads or highways are covered by multiple mobile networks. There are no guarantees that the vehicle will be connected to a wireless network providing minimum latency to connect to a remote management entity.

As discussed herein, this disclosure provides minimum latency for mobile vehicle connectivity when multiple mobile networks are available along a road or highway. Embodiments herein guarantee a sort of communication-based on technology availability.

The proposed solution can be configured to include the following components:
1. A new device will be designed to support the following wireless communication technologies. In one embodiment, the device supports GPS capability, and is installed on each self-driving vehicle and truck. Supported technologies include one or more of:
a. Satellite
b. 5G/4G LTE
c. Wi-Fi™
d. Zigbee™
e. LPWN
f. Bluetooth™
2. A Centralized server on the cloud which gather network counter states from all the wireless technologies implemented in the respective geographical regions. The server can be configured to support HTTP Rest or other suitable interface. The communication device in the vehicle will use the HTTP Rest interface to send the radio signal information and counter to the centralized server.

In one embodiment, satellite communications will be the first type of technology to use in remote areas.

While the vehicle is moving, the device in the respective vehicle gathers information about the available radio technologies (i.e., SNR, RSS, RSSI, Lat/long, latency, QoS) in the surrounding area and sends it to the centralized server. Basically, any radio technology in the surrounding area, whether this technology is anyone of the following (5G/4G LTE, WiFi, Zigbee, LPWN, Bluetooth), the device will gather the information for each radio network and send it to the centralized server.

The centralized server will use all the received information from all the devices within the self-driving vehicles/trucks and create a cognitive network. If desired, embodiments herein include implementing an algorithm to run in the centralized server (remote management entity) to instruct the vehicle when to hand over the satellite communication to other existing wireless technologies in the surrounding area on an as-needed basis.

In some situations like tunnels or forests, satellite communication may not be available. The centralized server or other suitable entity such as a management entity in the vehicle can be configured to select use of the most optimum one or more wireless networks available on the ground. Every condition for the vehicle communication is applicable for the drone communications.

Embodiments herein guarantee a connection for the self-driving vehicle/trucks in remote areas. Embodiments herein also alleviate a respective satellite communication load by switching to another means of communication as alternative wireless technologies are determined to be available. This newly selected communication links may support the following (5G/4G LTE, WiFi, Zigbee, LPWN, Bluetooth).

In contrast to conventional techniques, as further discussed herein, a communication management resource tracks availability of multiple types of wireless technologies at multiple geographical regions via tracking information. The management resource receives a current location of a first vehicle and uses the current location to determine that the first vehicle resides within a first geographical region of the multiple geographical regions. The management entity can be configured to receive information from the first vehicle regarding available wireless networks. The communication management resource then uses the tracking information to determine multiple types of wireless technologies supported at the current location in which the first vehicle resides. The communication management resource then selects amongst the multiple types of wireless technologies to establish wireless connectivity between the first vehicle and the remote network.

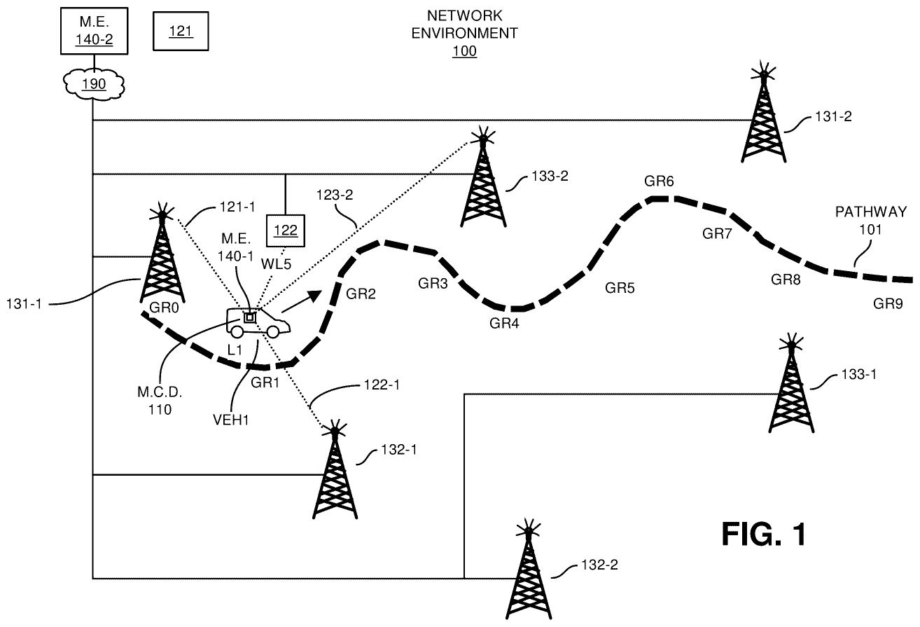

FIG. 1 is an example diagram illustrating a network environment supporting simultaneous connectivity to multiple wireless networks access according to embodiments herein.

As shown in FIG. 1, the network environment 100 includes management entity 140 (such as management entity 140-1, management entity 140-2, etc.), vehicle VEH1, and pathway 101. The network environment 100 further includes a mobile communication device 110 and/or management entity 140-1 disposed in the vehicle VEH1.

The mobile communication device 110 can be configured to execute a management resource 140-1 to perform various functions as discussed herein.

The network environment 100 can be configured to include implementation of a management entity 140-2 (such as a server providing control functions, controlling movement or other aspects of each of the vehicles traveling along the path 101). The management entity 140-2 and/or management entity 140-1 can be configured to select which of the multiple available wireless technologies and/or wireless networks to be used (or considered for use) by the communication device 110 in the vehicle VEH1 to communicate with the management entity 140-2.

Note that the management entity 140 (such as management entity 140-1 and/or management entity 140-2) and corresponding executed functionality can be co-located or disparately located with respect to each other. The management entity 140 can be configured to support any of the functionality as discussed herein.

Vehicle VEH1 (such as unmanned vehicle, computer controlled vehicle, remote controlled vehicle, etc.) travels long pathway 101 (such as road, highway, etc.) from location L1 to a desired destination such as from geographical region GR1 to geographical region GR9.

In one embodiment, the combination of the (remote) management entity 140-2 and/or the management entity 140-1 in the mobile communication device 110 controls operation such as movement of the vehicle VEH1 along a planned trajectory such as pathway 101.

Note that each of the components in network 100 can be implemented in any suitable manner. For example, (mobile) management entity 140-1 (such as a communication management resource) associated with or executed by the mobile communication device 110 in vehicle VEH1 can be implemented as communication management hardware, communication management software, or a combination of communication management hardware and communication management software. The (remote) management entity 140-2 can be implemented as remote management hardware, remote management software, or a combination of remote management hardware and remote management software. The mobile communication device 110 can be implemented as remote communication management hardware, communication management software, or a combination of communication management hardware and communication management software.

As previously discussed, in contrast to conventional techniques, the management entity 140-1 (communication management resource such as communication management hardware, communication management software or a combination of both) associated with the mobile communication device 110 can be configured to discover availability of different wireless networks via implementation of different wireless technologies and/or establish wireless connectivity between the mobile communication device 110 and each of one or more different wireless networks as the vehicle VEH1 and corresponding mobile communication device 110 travel along the pathway 101. As further discussed herein, discovery can include the communication device 110 communicating over a wireless communication link WL5 through station 222 and network 190 to the management entity 140-2. The management entity 140-2 can be configured to provide notification of different wireless networks and/or different wireless technologies supported in the geographical region GR1. Additionally, or alternatively, the management entity 140-1 and/or communication device 110 can be configured to transmit wireless probe requests in the geographical region GR1 to determine what wireless networks (and wireless technologies) are available to support wireless connectivity and communications to the management entity 140-1.

For example, while at location L1 (which resides in geographical region GR1), the management entity 140-1 of vehicle VEH1 (or management entities of other vehicles) can be configured to discover availability of wireless network 131, wireless network 132, and wireless network 133. The management entity 140-1 can be configured to discover wireless networks and communicate notification of those discovered networks to the management entity 140-2. Based on control feedback from the management entity 140-2, the management entity 140-1 can be configured to establish the wireless communication link 121-1 between the mobile communication device 110 and the wireless base station 131-1 (such as associated with a first wireless network 131). The management resource 140-1 can be configured to establish wireless communication link 122-1 between the mobile communication device 110 and the wireless base station 132-1 (such as associated with a second wireless network 132). The communication management resource 140-1 can be configured to establish wireless communication link 123-2 between the mobile communication device 110 and the wireless base station 133-2 (such as associated with a third wireless network 133). Each of these links may be temporary and/or used simultaneously. Wireless links may be terminated if they are not needed.

Thus, the wireless connectivity in this example includes multiple simultaneously used wireless communication links. As further discussed herein, the management entity 140-1 and/or corresponding mobile communication device 110 or other suitable entity connects to different wireless base stations as the vehicle VEH1 travels along the pathway 101.

For example, as further discussed herein, when the vehicle VEH1 resides in geographical region GR1, the mobile communication device 110 potentially connects to different wireless base stations in corresponding available wireless networks; when the vehicle VEH1 resides in geographical region GR2, the mobile communication device 110 potentially connects to different wireless base stations in corresponding available wireless networks; when the vehicle VEH1 resides in geographical region GR3, the mobile communication device 110 potentially connects to different wireless base stations in corresponding available wireless networks; and so on.

As the vehicle VEH1 travels along the pathway 101, the management entity 140 can be configured to determine which of multiple wireless base stations and corresponding wireless technologies can be used by the communication device 110 to establish redundant wireless connectivity through the network 190 with the management entity 140-2.

In one embodiment, each of the multiple wireless networks 131, 132, 133, etc., is operated by a different wireless network service provider supported by different SIM (Subscriber Identity Module) information. The SIM information may be stored in a respective communication device of the vehicle. The SIM includes information such as an identification number associated with the communication device and/or user, passwords, phone numbers, information supporting wireless connectivity, and messages.

Note that other available wireless networks providing connectivity of the mobile communication device 110 to the network 190 and remote management entity 140-2 do not require use of SIM information. Thus, the mobile communication device 110 can be configured to connect to the one or more networks and management entity 140-2 in many different ways using any of one or more different wireless communication protocols.

In further example embodiments, one or more of the management entity 140-2 and/or management entity 140-1 can be configured to produce tracking information 121. Via the tracking information 121, the management entities 140-1 and/or 140-2 individually or jointly track availability of multiple different types of wireless technologies (and support stations) available at multiple different geographical regions in the network environment 100.

As further discussed herein, via the tracking information 121, the one or more management entities 140 determine multiple types of wireless technologies (such as wireless communication protocols) supported at a respective current location (geographical region) in which the vehicle VEH1 resides in any suitable manner. For example, assume that the vehicle VEH1 resides in geographical region GR1. The management entity 140-2 can be configured to notify the management entity 140-1 of the different possible wireless networks and wireless technologies supported in the geographical region GR1. The management entity 140-1 also can be configured to send out beacons to discover availability of the different wireless networks using the different wireless technologies. Based on performance measurements of the possible available wireless networks, a respective management entity (140-1 and/or 140-2) then selects amongst the multiple types of wireless technologies and/or wireless networks to establish wireless connectivity between the first vehicle VEH1 and the remote network 190 and management entity 140-2.

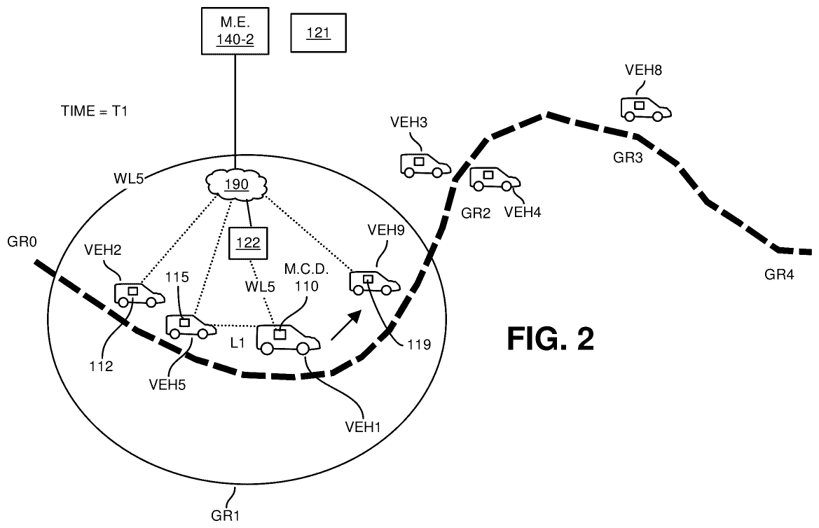

FIG. 2 is an example diagram illustrating a mobile communication device simultaneously in communication with one or more wireless networks according to embodiments herein.

As shown in FIG. 2, multiple vehicles in the geographical region GR1 can be configured to connect to the remote network 190 and communicate via respective one or more wireless communication links. One type of wireless network such as satellite 222 supports satellite communications. The management entity 140-1 and/or communication device 110 in vehicle VEH1 can be configured to communicate over a satellite connection (WL5) through satellite 222 and network 190 to the management entity 140-2. Via the satellite connectivity between the management entity 140-2 and the management entity 140-1, the management entity 140-2 can be configured to provide notification to the management entity 140-1 of which of multiple wireless networks are potentially available to support wireless connectivity between the management entity 140-1 and management entity 140-2.

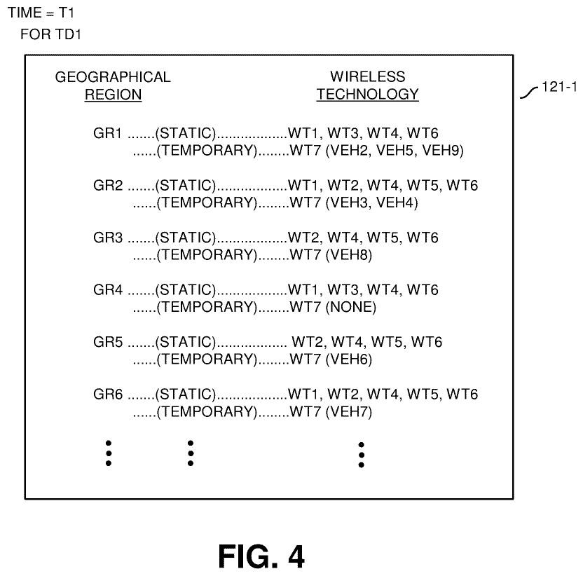

For example, as further discussed herein, embodiments herein include the mobile communication device 110 providing notice of its location through the satellite 222 and network 190 to the management entity 140-2. Via mapping, the management entity 140-2 determines from received location information L1 that the vehicle VEH1 and corresponding communication device 110 and management entity 140-1 reside in geographical region GR1. Via the tracking information 121, the management entity 140-2 determines which of multiple different wireless technologies are available at the location L1 and geographical region GR1. As further discussed herein, in one embodiment, via tracking information 121-1 (FIG. 4), the management entity 140-2 communicates the identities of the wireless technologies WT1, WT3, WT4, WT6, and WT7 through the network 190 and satellite 222 over the wireless communication link to the management entity 140-1, communication device 110, and thus vehicle VEH1. Thus, the communication device 110 is aware of which wireless technologies may be best to use or consider for use in the geographical region GR1. The management entity 140-1 and/or communication device 110 then performs one or more tests to determine and select amongst the wireless communication links that support a lowest latency communications between the vehicle VEH1 (communication device 110 and management entity 140-1) and the remote management entity 140-2.

In certain instances, a respective mobile communication device 110 can be configured to connect to the remote network 190 through one or more ground based wireless base stations and/or satellite 222. Additionally, or alternatively, one or more wireless access points in respective other vehicles may provide one or more wireless communication links provided by the other respective vehicle to the remote network 190 and management entity 140-2.

As a more specific example, in one embodiment, each of the vehicles VEH2, VEH5, and VEH9 can be configured to support wireless tethering in which other mobile communication devices (such as communication device 110) communicate through the mobile communication device of those vehicles to access the corresponding remote network 190 and management entity 140-2. In such an instance, the mobile communication device 110 can be configured to establish wireless connectivity with the communication device 115 in vehicle VEH5 to access the remote network 190 and communicate with the management entity 140-2 via communications through the vehicle VEH5 and network 190 to the management entity 140-2; the mobile communication device 110 can be configured to establish wireless connectivity with the communication device 112 in vehicle VEH2 to access the remote network 190 and communicate with the management entity 140-2 via communications through the vehicle VEH2 and network 190 to the management entity 140-2; the mobile communication device 110 can be configured to establish wireless connectivity with the communication device 119 in vehicle VEH9 to access the remote network 190 and communicate with the management entity 140-2 via communications through the vehicle VEH9 and network 190 to the management entity 140-2; and so on.

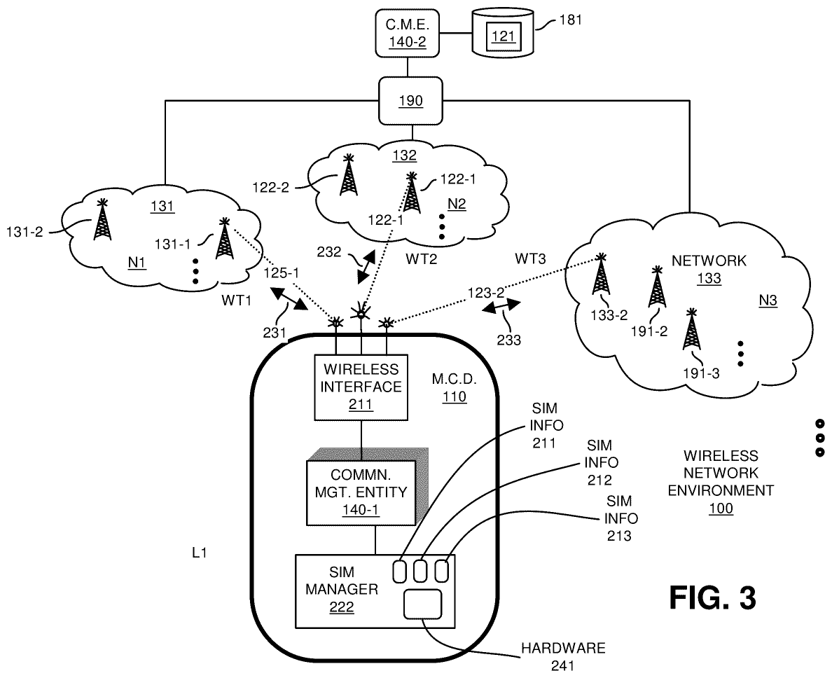

FIG. 3 is an example diagram illustrating details of a mobile communication device and connectivity to multiple wireless networks according to embodiments herein.

As shown in this example, the mobile communication device 110 includes wireless interface 211, communication management entity 140-1, and SIM manager 222.

As its name suggests, the SIM (Subscriber Identity Module) manager 222 manages SIM information associated with the mobile communication device 110. For example, assume that the operator associated with the mobile communication device 110 subscribes to use of multiple different wireless networks (such as Satellite, 5G, 4G, LTE, Wi-Fi™, Zigbee™, LORAN™, LoranPWN, Bluetooth™, etc., in the network environment 100.

In one embodiment, each instance of SIM information enables a respective mobile communication device use of a corresponding wireless network. More specifically, the SIM information 211 (a.k.a., first connectivity information) enables the mobile communication device 110 to communicate via wireless technology WT1 (and corresponding first wireless communication protocol) with one or more of wireless base stations 131-1, 131-2, etc., disposed in the wireless network 131 (a.k.a., wireless network N1); the SIM information 212 (a.k.a., second wireless connectivity information) enables the mobile communication device 110 to communicate via wireless technology WT2 (and corresponding second wireless communication protocol) with one or more of wireless base stations 132-1, 132-2, etc., disposed in the wireless network 132 (a.k.a., wireless network N2); the SIM information 213 (a.k.a., third wireless connectivity information) enables the mobile communication device 110 to communicate via wireless technology WT3 (and corresponding third wireless communication protocol) with one or more of wireless base stations 133-1, 133-2, etc., disposed in the wireless network 133 (a.k.a., wireless network N3); and so on.

As previously discussed, note again that certain wireless technologies implemented in network environment 100 do not require use of SIM information.

Accordingly, via different types of radio interfaces of the communication device 110 supporting different wireless technologies, the communication device 110 has different capabilities of communicating with a respective mobile located management entity 140-2.

As further shown, wireless network 131 (network N1) includes wireless base station 131-1, wireless base station 131-2, etc. As previously discussed, the wireless base stations 131-1, 131-2, etc., are disposed along the pathway 101 at different locations to provide one or more communication devices at different locations access to the remote management entity 140-2. As further discussed herein, wireless network 131 may not support wireless connectivity to communication devices in every geographical region along pathway 101.

Wireless network 132 includes wireless base station 132-1, wireless base station 132-2, etc. As previously discussed, the wireless base stations 132-1, 132-2, etc., are disposed along the pathway 101 at different locations to provide one or more communication devices at different locations access to the remote management entity 140-2. As further discussed herein, wireless network 131 may not support wireless connectivity to communication devices in every geographical region along pathway 101.

Wireless network 133 includes wireless base station 133-1, wireless base station 133-2, wireless base station 133-3, etc. As previously discussed, the wireless base stations 133-1, 133-2, etc., are disposed along the pathway 101 at different locations to provide one or more communication devices at different locations access to the remote management entity 140. As further discussed herein, wireless network 133 may not support wireless connectivity to communication devices in every geographical region along pathway 101.

In one embodiment, the management entity 140-1 or management entity 140-2 or other suitable entity selects amongst multiple possible wireless networks 131, 132, 133, etc., which provide wireless connectivity to the remote management entity 140-2 depending upon a corresponding measured latency associated with the possible wireless communication links 125-1, 122-1, and 123-2, thus providing connectivity of the mobile communication device 110 to the remote management entity 140. Repository 181 stores tracking information 121.

FIG. 4 is an example diagram illustrating dynamic tracking information indicating availability of wireless networks in different geographical regions according to embodiments herein.

As previously discussed, the one or more management entities 140 as discussed herein keep track of the different available networks and corresponding supported wireless technologies via tracking information 121.

For example, in one embodiment, prior to time T1, the management entity 140 receives feedback from multiple each of the vehicles VEH1, VEH2, VEH3, etc., or other vehicles and corresponding mobile communication devices traveling through the different geographical regions GR1, GR2, GR3, GR4, GR5, etc., along pathway 101 in the network environment 100. The feedback (such as wireless communications transmitted from each of the communication devices in the different vehicles) indicates which if any of the different wireless technologies and respective wireless networks are available at a respective geographical location in the network environment 100. The received feedback from vehicles traveling on pathway 101 is used to produce tracking information 121.

In certain instances, the different vehicles and corresponding communication devices (such as mobile wireless access points) provide other mobile communication devices and corresponding vehicles access to the respective remote network 190. Because the vehicles may be moving through the network environment 100 and corresponding pathway 101, such mobile wireless access points (such as in vehicles) may be available only for a short period of time as the respective vehicle moves to the corresponding geographical region.

On the other hand, the network environment includes one or more wireless base stations disposed at fixed locations to support wireless connectivity to the one or more vehicles traveling along the pathway 101. Accordingly, in one embodiment, the tracking information 121-1 associated with time T1 (or timeslot TD1) indicates the availability of fixed wireless access points (static) as well as mobile wireless access points (temporary).

More specifically, in one embodiment, from tracking information 121-1 in FIG. 4, at or around time T1, the management entity 140-1 or 140-2 detects presence of the vehicle VEH2 and corresponding mobile communication device (wireless access point 112) in the geographical region GR1; the management entity 140 detects presence of the vehicle VEH5 and corresponding mobile communication device (wireless access point 115) in the geographical region GR1; the management entity 140 detects presence of the vehicle VEH9 and corresponding mobile communication device (wireless access point 119) in the geographical region GR1. The information indicating presence of mobile wireless base stations in respective vehicles (mobile wireless base station 112 in vehicle VEH2, mobile wireless base station 115 in vehicle VEH5, mobile wireless base station 119 in vehicle VEH9, etc.) can be received from each of the mobile wireless base stations as they pass through the different geographical regions.

In such an instance, based on either knowing that the vehicles are present in the geographical region GR1 from a scheduled itinerary of each vehicle and/or actual feedback (as previously discussed) from each of the vehicles indicating presence of the vehicles and corresponding mobile wireless access points in the geographical region GR1, the management entity 140 as discussed herein updates the tracking information 121-1 to indicate available of respective mobile wireless access points in the geographical region GR1. In addition to temporary available mobile wireless base stations in vehicles, based on a respective history of prior use of respective fixed wireless base stations supporting communications in a respective geographical region, the management entity 140 (management entity 140-1 and/or management entity 140-2) produces the tracking information 121-1 to indicate the different wireless technologies supported by different fixed wireless networks and corresponding static wireless base stations that are stationary in the network environment 100.

Thus, whether fixed or mobile, the management entity 140 tracks which of the different possible wireless technologies and corresponding wireless networks are supported in each geographical region and stores such information in the tracking information 121-1 for time T1 or time duration TD1.

Further in this example embodiment, based on feedback from one or more entities and prior history of use by other vehicles and corresponding communication devices: i) the management entity 140 (i.e., management entity 140-1 and/or management entity 140-2) produces the tracking information 121-1 to indicate that geographical region GR1 supports wireless technology WT1 (such as via first type of wireless network, first wireless communication protocol, and first wireless connectivity type via one or more corresponding first wireless base stations); ii) the management entity 140 produces the tracking information 121-1 to indicate that geographical region GR1 supports wireless technology WT3 (such as via third type of wireless network, third wireless communication protocol, and third wireless connectivity type via corresponding one or more thirds wireless base stations); and so on. Wireless technologies WT2, WT5 are not supported in geographical region GR1.

Accordingly, embodiments herein include: i) the management entity 140 or other suitable entity producing the tracking information 121-1 to indicate first geographical regions (GR1, GR2, GR4, GR6, etc.) supporting wireless technology WT1 supporting first wireless connectivity; ii) the management entity 140 or other suitable entity producing the tracking information 121-1 to indicate second geographical regions (GR2, GR3, GR5, GR6, etc.) supporting wireless technology WT2 supporting second wireless connectivity; iii) the management entity 140 or other suitable entity producing the tracking information 121-1 to indicate third geographical regions (GR1, GR4, etc.) supporting third wireless technology WT3 supporting wireless connectivity; iv) the management entity 140 or other suitable entity producing the tracking information 121-1 to indicate fourth geographical regions (GR1, GR2, GR3, GR4, GR5, GR6, etc.) supporting fourth wireless technology WT4 supporting wireless connectivity; v) the management entity 140 or other suitable entity producing the tracking information 121-1 to indicate fifth geographical regions (GR2, GR3, GR5, GR6, etc.) supporting wireless technology WT5 supporting second wireless connectivity; and so on.

Additionally, as previously discussed, the management entity 140 can be configured to track availability of different mobile wireless access points disposed in vehicles that reside in a respective geographical region. For example, assume that the mobile wireless access points support wireless communications in accordance with wireless technology WT7 and corresponding wireless communication protocol. The management entity 140 can be configured to receive first schedule information and/or location information indicating the time duration (TD1) in which the vehicle VEH1 and corresponding mobile communication device 110 will be present in the geographical region GR1; the management entity 140 can be configured to receive schedule information indicating that the vehicle VEH2 and corresponding mobile wireless access point 112 (a.k.a., mobile communication device) will be present in the geographical region GR1 to support wireless tethering of other mobile communication devices through the respective mobile wireless access point 112 to the remote network 190 during the time duration TD1; the management entity 140 can be configured to receive schedule information indicating that the vehicle VEH5 and corresponding mobile wireless access point 115 (a.k.a., mobile communication device) will be present in the geographical region GR1 to support wireless tethering of other mobile communication devices through the respective mobile wireless access point 115 of vehicle VEH5 to the remote network 190 during the time duration TD1; the management entity 140 can be configured to receive schedule information indicating that the vehicle VEH9 and corresponding mobile wireless access point 119 (a.k.a., mobile communication device) will be present in the geographical region GR1 to support wireless tethering of other mobile communication devices through the respective mobile wireless access point 119 of vehicle VEH9 to the remote network 190 during the time duration TD1; and so on.

As an alternative to receiving schedule information, the management entity 140 can be configured to receive notification from the one or more vehicles in the network environment of the availability of the different multiple wireless access points in the geographical regions at or around time T1.

Assume that the mobile wireless access points 112, 115, 119, etc., support a wireless technology WT7 and corresponding wireless communication protocol. Note that the wireless technology WT7 alternatively may be any one of the multiple wireless technologies WT1, WT2, WT3, WT4, WT5, WT6, etc., (wireless technologies such as Satellite, 5G, 4G, LTE, Wi-Fi™, Zigbee™, LORAN™, LoranPWN, Bluetooth™, etc.) or a different wireless technology. In other words, each of the wireless base stations 112, 115, 119, etc., as discussed herein can be configured to support any of the wireless technologies WT1, WT2, WT3, WT4, WT5, WT6.

In such an instance, based on the received information, the management entity 140 produces the tracking information 121-1 for geographical region GR1 to indicate availability of wireless technology associated with multiple mobile wireless access points or mobile wireless base stations 112, 115, 119, as well as static information indicating availability of fixed wireless technologies WT1, WT3, WT4, WT6, etc., and supporting connectivity to wireless networks N1, N3, N4, N6, and corresponding fixed wireless base stations to access remote network and communicate with management entity 140-2 (such as a management entity controlling operation of the vehicles VEH1, VEH2, VEH3, VEH4, VEH5, VEH6, VEH7, VEH8, VEH9, etc.).

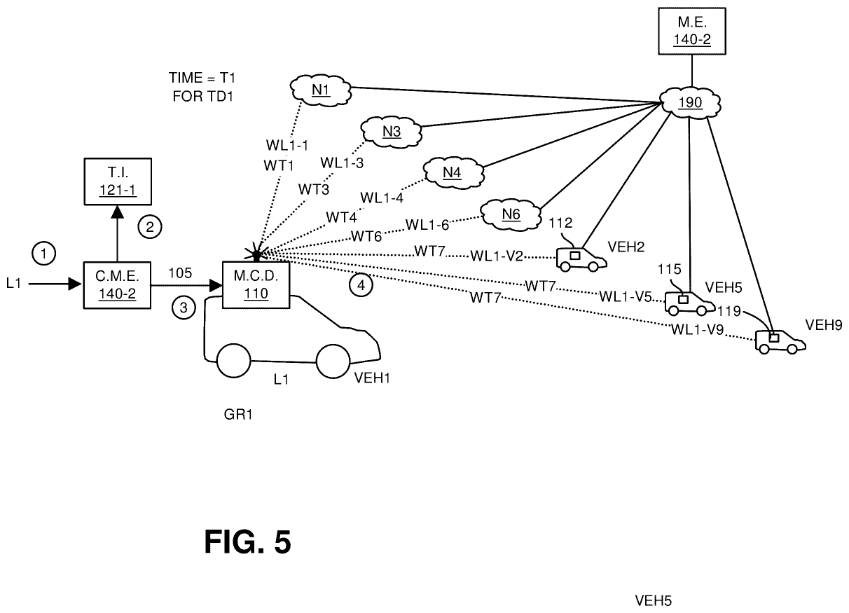

FIG. 5 is an example diagram illustrating detection of multiple different wireless networks in a network environment and testing of same to determine performance according to embodiments herein.

While in geographical region GR1, in certain embodiments, vehicle VEH1 needs to communicate with the management entity 140-2 or management entity 140-1 to determine which wireless technologies may be available in geographical region GR1. As previously discussed, the mobile communication device 110 may initially communicate with the management entity 140-2 via a satellite communication link through network 190 or any of the possible wireless technologies as previously discussed.

Initially, in processing operation #1, the vehicle VEH1 determines its location and supplies its location to management entity 140-1. The management entity 140 (such as management entity 140-1 and/or management entity 140-2) receives the location information L1 of vehicle VEH1 and determines that the vehicle VEH1 resides in the geographical region GR1. As previously discussed, the management entity 140-2 may receive the location information L1 transmitted from the management entity 140-1 over a wireless satellite link (WL5) to the management entity 140-2.

As previously discussed, the tracking information 121-1 tracks availability of multiple different types of wireless technologies (and corresponding networks) available in each of the multiple geographical regions of network environment 100. In this example embodiment, via the tracking information 121-1, the management entity 140 determines multiple types of wireless technologies supported at the current location L1 and geographical region GR1 in which the first vehicle VEH1 an data communication device 110 reside. As previously discussed, the tracking information 121-1 can be created from prior use of multiple types of wireless technologies discovered and used by multiple vehicles passing through the pathway 101 or scheduled presence of one or more mobile wireless access points in each of the different geographical regions.

Further in this example embodiment, in processing operation #2, the management entity 140 (such as management hardware, management software, or a combination of management hardware and management software) determines the different wireless technologies and corresponding networks supporting wireless access in geographical region GR1 via the tracking information 121-1 at or around time T1 such as during time duration TD1. For example, via the tracking information 121-1, the management entity 140 can be configured to determine that the wireless technology supported in geographical region GR1 (in which location L1 resides) includes wireless technology WT1, wireless technology WT3, wireless technology WT4, wireless technology WT6, and wireless technology WT7.

More specifically, via mapping of the location L1 to geographical region GR1, and mapping of geographical region GR1 to different wireless technologies, the management entity 140 produces input 105 indicating the different wireless technologies available in the geographical region GR1. Thus, the mobile communication device 110 receives input indicating the multiple types of wireless technologies supported at the current location L1 in which the vehicle VEH1 resides. This alleviates the mobile communication device 110 from having to discover by itself which of the wireless technologies are available for use in geographical region GR1.

As previously discussed, the tracking information 121-1 can be configured to indicate which of the different available wireless technologies provide the best performance in the geographical region GR 1. In such an instance, the input 105 indicates which of the different wireless technologies is potentially to be used by the mobile communication device 110 to establish respective dual or multi-link wireless connectivity to the management entity 140-2. However, it is noted that performance of the respective wireless technologies and corresponding communication links may vary over time. In such an instance, it is desirable for the mobile communication device 110 to initiate a performance test to determine which of the candidate wireless technologies will provide best connectivity between the communication device 110 and the management entity 140-2.

To this end, in processing operation #4, the mobile communication device of vehicle VEH1 at location L1 in geographical region GR1 determines a performance of each of the multiple types of available wireless technologies WT1, WT3, WT4, WT6, and WT7 supported at the current location L1 by testing a performance of each of the respective wireless technologies WT1, WT3, WT4, WT6, and WT7. Testing the performance of each of the different types of available wireless technologies can include establishing a respective wireless link between the mobile communication device 110 (as the vehicle VEH1 is moving through the pathway 101 in network environment 100) and each of the different networks supporting the different wireless technologies.

For example, in one embodiment, the mobile communication device 110 establishes a respective wireless link associated with each of the available wireless technologies. The management entity 140-1 and/or communication device 110 tests each of the candidate wireless technologies to determine which of the multiple wireless technologies as specified by the tracking information 121-1 for geographical region GR1 are best for establishing at least dual wireless connectivity between the mobile communication device 110/management entity 140-1 in vehicle VEH1 and the management entity 140-2.

More specifically, for testing purposes, the communication device 110 establishes wireless link WL1-1 between the mobile communication device 110 and the first network N1 supporting the first wireless communication technology WT1 (wireless communication protocol #1); the mobile communication device 110 determines a respective performance (such as latency, bandwidth, etc.) of the wireless WL1-1 and wireless technology WT1 via a latency and/or bandwidth test. For example, the communication device 110 and/or network N1 can be configured to determine a latency and/or bandwidth supported between the mobile communication device 110 and the management entity 140-2. As further discussed herein, the management entity 140 produces performance information P1-1 to indicate the performance of wireless link WL1-1 and/or full path connectivity between the mobile communication device 110 and the management entity 140-2 including the wireless link WL1-1. In one embodiment, the performance information P1-1 indicates a latency associated with wireless technology WT1 between a time of communicating a message from the communication device 110 over the wireless communication link WL1-1 and network 190 and a time of the management entity 140-2 receiving the message. Round-trip times of messages between the mobile communication device 110 and the management entity 140-2 also can be used to determine performance associated with the wireless link WL1-1 and connection to the management entity 140-2 via wireless technology WT1. Least latency is desired.

For further testing purposes, the communication device 110 establishes wireless link WL1-3 between the mobile communication device 110 and the network N3 supporting the wireless communication technology WT3 (wireless communication protocol #3); the mobile communication device 110 determines a respective performance (such as latency, bandwidth, etc.) of the wireless WL1-3 via a latency and/or bandwidth test. For example, the communication device 110 and/or network N3 can be configured to determine a latency and/or bandwidth supported between the mobile communication device 110 and the management entity 140-2. The management entity 140 produces performance information P1-3 to indicate the performance of wireless link WL1-3 and/or full path connectivity between the mobile communication device 110 and the management entity 140-2 including the wireless link WL1-3. In one embodiment, the performance information P1-3 indicates a latency of wireless technology WT3 between a time of communicating a message from the communication device 110 over the wireless communication link WL1-3 and network 190 and a time of the management entity 140-2 receiving the message. Round-trip times of messages between the mobile communication device 110 and the management entity 140-2 also can be used to determine performance associated with the wireless link WL1-3 and connection to the management entity 140-2 via wireless technology WT3.

For testing purposes, the communication device 110 establishes wireless link WL1-4 between the mobile communication device 110 and the network N4 supporting the fourth wireless communication technology WT4 (wireless communication protocol #4); the mobile communication device 110 determines a respective performance (such as latency, bandwidth, etc.) of the wireless WL1-4 via a latency and/or bandwidth test. For example, the communication device 110 and/or network N4 can be configured to determine a latency and/or bandwidth supported between the mobile communication device 110 and the management entity 140-2. The management entity 140 produces performance information P1-4 to indicate the performance of wireless link WL1-4 and/or full path connectivity between the mobile communication device 110 and the management entity 140-2 including the wireless link WL1-4. In one embodiment, the performance information P1-4 indicates a latency between a time of communicating a message from the communication device 110 over the wireless communication link WL1-4 and network 190 and a time of the management entity 140-2 receiving the message. Round-trip times of messages between the mobile communication device 110 and the management entity 140-2 also can be used to determine performance associated with the wireless link WL1-4 and connection to the management entity 140-2 via wireless technology WT4.

For testing purposes, the communication device 110 establishes wireless link WL1-6 between the mobile communication device 110 and the network N6 supporting the wireless communication technology WT6 (wireless communication protocol #6); the mobile communication device 110 determines a respective performance (such as latency, bandwidth, etc.) of the wireless WL1-6 via a latency and/or bandwidth test. For example, the communication device 110 and/or network N6 can be configured to determine a latency and/or bandwidth supported between the mobile communication device 110 and the management entity 140-2. The management entity 140 produces performance information P1-6 to indicate the performance of wireless link WL1-6 and/or full path connectivity between the mobile communication device 110 and the management entity 140-2 including the wireless link WL1-6. In one embodiment, the performance information P1-6 indicates a latency between a time of communicating a message from the communication device 110 over the wireless communication link WL1-6 and network 190 and a time of the management entity 140-2 receiving the message. Round-trip times of messages between the mobile communication device 110 and the management entity 140-2 also can be used to determine performance associated with the wireless link WL1-6 and connection to the management entity 140-2 via wireless technology WT6.

For testing purposes, the communication device 110 establishes wireless link WL1-V2 between the mobile communication device 110 and the mobile wireless access point in vehicle VEH2 supporting the wireless communication technology WT7 (wireless communication protocol #7 or other wireless communication protocol); the mobile communication device 110 determines a respective performance (such as latency, bandwidth, etc.) of the wireless WL1-V2 via a latency and/or bandwidth test. For example, the communication device 110 and/or management entity can be configured to determine a latency and/or bandwidth supported between the mobile communication device 110 and the management entity 140-2 (i.e., path including wireless communication link WL1-V2 through the mobile wireless access point 112 of vehicle VEH2 and network 190 to the management entity 140-2). The management entity 140 produces performance information P1-7-2 to indicate the performance of wireless link WL1-V2 and/or full path connectivity between the mobile communication device 110 and the management entity 140-2 including the wireless link WL1-V2. In one embodiment, the performance information P1-7-2 indicates a latency between a time of communicating a message from the communication device 110 over the wireless communication link WL1-V2 and network 190 and a time of the management entity 140-2 receiving the message. Round-trip times of messages between the mobile communication device 110 and the management entity 140-2 also can be used to determine performance associated with the wireless link WL1-V2 and connection to the management entity 140-2 via wireless technology WT7.

For testing purposes, the communication device 110 establishes wireless link WL1-V5 between the mobile communication device 110 and the mobile wireless access point in vehicle VEH5 supporting the wireless communication technology WT7 (wireless communication protocol #7 or other wireless communication protocol); the mobile communication device 110 determines a respective performance (such as latency, bandwidth, etc.) of the wireless WL1-V5 via a latency and/or bandwidth test. For example, the communication device 110 and/or management entity can be configured to determine a latency and/or bandwidth supported between the mobile communication device 110 and the management entity 140-2 (i.e., path including wireless communication link WL1-V5 through the mobile wireless access point of vehicle VEH5 and network 190 to the management entity 140-2). The management entity 140 produces performance information P1-7-5 to indicate the performance of wireless link WL1-V5 and/or full path connectivity between the mobile communication device 110 and the management entity 140-2 including the wireless link WL1-V5. In one embodiment, the performance information P1-7-5 indicates a latency between a time of communicating a message from the communication device 110 over the wireless communication link WL1-V5 and network 190 and a time of the management entity 140-2 receiving the message. Round-trip times of messages between the mobile communication device 110 and the management entity 140-2 also can be used to determine performance associated with the wireless link WL1-V5 and connection to the management entity 140-2 via wireless technology WT7.

For testing purposes, the communication device 110 establishes wireless link WL1-V9 between the mobile communication device 110 and the mobile wireless access point in vehicle VEH9 supporting the wireless communication technology WT7 (wireless communication protocol #7 or other wireless communication protocol); the mobile communication device 110 determines a respective performance (such as latency, bandwidth, etc.) of the wireless WL1-V9 via a latency and/or bandwidth test. For example, the communication device 110 and/or management entity can be configured to determine a latency and/or bandwidth supported between the mobile communication device 110 and the management entity 140-2 (i.e., path including wireless communication link WL1-V9 through the mobile wireless access point of vehicle VEH9 and network 190 to the management entity 140-2). The management entity 140 produces performance information P1-7-9 to indicate the performance of wireless link WL1-V9 and/or full path connectivity between the mobile communication device 110 and the management entity 140-2 including the wireless link WL1-V9. In one embodiment, the performance information P1-7-9 indicates a latency between a time of communicating a message from the communication device 110 over the wireless communication link WL1-V9 and network 190 and a time of the management entity 140-2 receiving the message. Round-trip times of messages between the mobile communication device 110 and the management entity 140-2 also can be used to determine performance associated with the wireless link WL1-V9 and connection to the management entity 140-2 via wireless technology WT7.

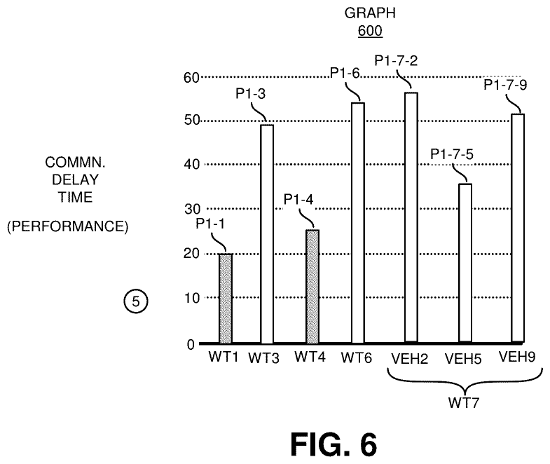

An example of the generated performance information P1-1, P1-3, P1-4, P1-6, P1-7-2, P1-7-5, and P1-7-9 is shown in FIG. 6.

FIG. 6 is an example diagram illustrating generation and comparison of performance information for each of multiple available wireless networks in a given geographical region according to embodiments herein.

Based on the performance information, the management entity 140-2, the communication device 110, and/or management entity 140-1 in the first vehicle VEH1 determines which of the multiple available wireless technologies and corresponding wireless technologies supports the best performance (such as lowest latency communication paths between the communication device 110 and the management entity 140-2).

More specifically, in this embodiment, the communication device 110 and/or management entity 140-1 selects amongst the multiple types of wireless technologies to establish wireless connectivity between the first vehicle and the remote network 190. For example, the wireless technology WT1 and corresponding wireless network N1 provide performance P1-1 and wireless technology WT4 and corresponding wireless network N4 provide performance P1-4. P1-1 and P1-4 provide the lowest latency and therefore best connectivity between the mobile communication device 110 of vehicle VEH1 and the management entity 140-2. Accordingly, in processing operation #5, the two wireless technologies wireless technology WT1 (network N1, performance information P1-1) and wireless technology WT4 (network N4, performance information P1-4) are chosen and implemented to provide simultaneous wireless connectivity between the mobile communication device and the management entity 140-2.

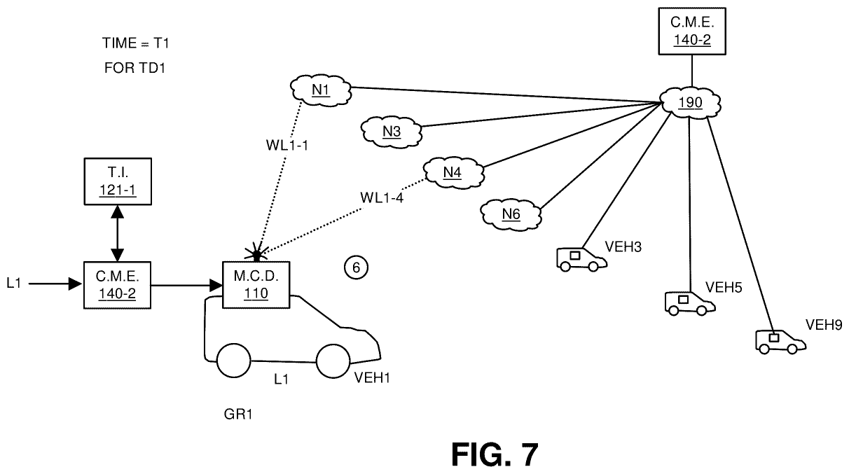

FIG. 7 is an example diagram illustrating selection of multiple wireless networks and simultaneous use of the selected wireless networks to communicate with a remote communication management entity according to embodiments herein.

As previously discussed, from the multiple types of wireless technologies WT1, WT3, WT4, WT6, and WT7 supported at the current location L1 in the geographical region GR1, the mobile communication device 140-1 selects the wireless technology WT1 to support a first wireless communication link WL1-1 (wireless network N1) between the vehicle VEH1 and the remote network 190 to communicate with the management entity 140-2 (controller). From the multiple types of wireless technologies WT1, WT3, WT4, WT6, and WT7 supported at the current location L1 in the geographical region GR1, the mobile communication device 140-1 also selects the wireless technology WT4 to support wireless communication link WL1-4 (wireless network N4) between the vehicle VEH1 and the remote network 190 to communicate with the management entity 140-2 (controller).

In one embodiment, in processing operation #6, the wireless communication link WL1-1 and the wireless communication link WL1-4 are simultaneously implemented/used by the communication device 110 in the vehicle VEH1 to support redundant wireless connectivity between the vehicle VEH1 and the remote network 190. The redundancy ensures that the mobile communication device 110 is able to communicate with the remote controller (management entity 140-2) to provide feedback information (odometer information, speed, vehicle maintenance/diagnostic information, poor road conditions such as ice, temperature, etc.) as previously discussed as well as receive control information from the management entity 140-2 even if one of the redundant links (WL1-1 or WL1-4) happens to fail while the vehicle is in the geographical region GR1.

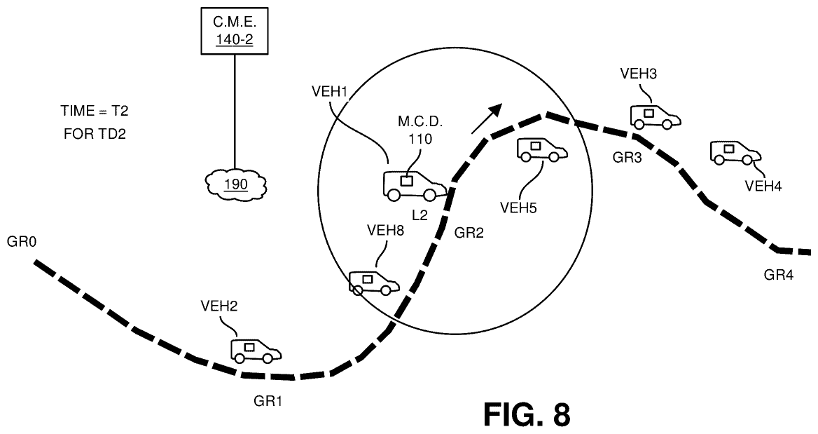

FIG. 8 is an example diagram illustrating movement of a mobile communication device to a second geographical region according to embodiments herein.

As shown, the vehicle VEH1 travels to geographical region GR2 at or around time T2. The vehicle WEH1 resides in the geographical region GR2 for time duration TD2.

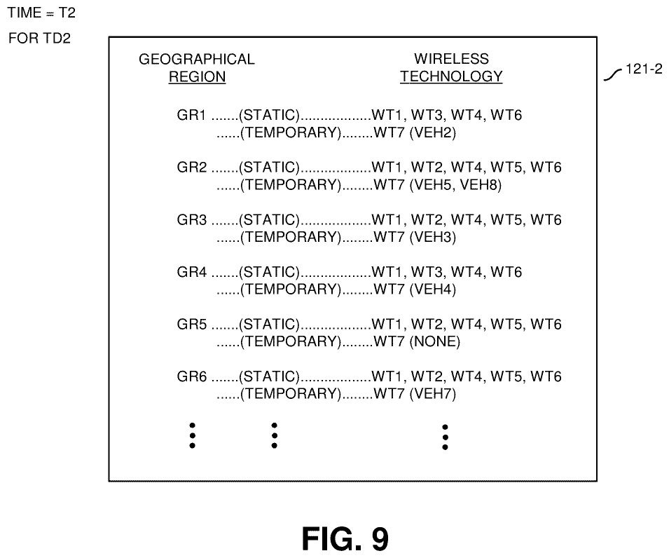

FIG. 9 is an example diagram illustrating dynamic tracking information indicating availability of wireless networks in different geographical regions according to embodiments herein.

As previously discussed, the one or more management entities 140 as discussed herein keep track of the different available networks and corresponding supported wireless technologies via tracking information 121.

For example, in one embodiment, prior to time T2, the management entity 140 receives feedback from multiple each of the vehicles VEH1, VEH2, VEH3, etc., or other vehicles and corresponding mobile communication devices traveling through the different geographical regions GR1, GR2, GR3, GR4, GR5, etc., along pathway 101 in the network environment 100. The feedback (such as wireless communications transmitted from each of the communication devices in the different vehicles) indicates which if any of the different wireless technologies and respective wireless networks are available at a respective geographical location in the network environment 100. The received feedback from vehicles traveling on pathway 101 is used to produce tracking information 121.

In certain instances, the different vehicles and corresponding communication devices (such as mobile wireless access points) provide other mobile communication devices and corresponding vehicles access to the respective remote network 190. Because the vehicles may be moving through the network environment 100 and corresponding pathway 101, such mobile wireless access points (such as in vehicles) may be available only for a short period of time as the respective vehicle moves to the corresponding geographical region.

On the other hand, the network environment includes one or more wireless base stations disposed at fixed locations to support wireless connectivity to the one or more vehicles traveling along the pathway 101. Accordingly, in one embodiment, the tracking information 121-1 associated with time T2 (or timeslot TD2) indicates the availability of fixed wireless access points (static) as well as mobile wireless access points (temporary).

More specifically, in one embodiment, from tracking information 121-2 in FIG. 9, at or around time T2, the management entity 140-1 or 140-2 detects presence of the vehicle VEH2 and corresponding mobile communication device (wireless access point 112) in the geographical region GR1. The information indicating presence of mobile wireless base stations in respective vehicles can be received from each of the mobile wireless base stations as they pass through the different geographical regions.

In such an instance, based on either knowing that the vehicles are present in the geographical region GR1 from a scheduled itinerary of each vehicle and/or actual feedback (as previously discussed) from each of the vehicles indicating presence of the vehicles and corresponding mobile wireless access points in the geographical region GR1, the management entity 140 as discussed herein updates the tracking information 121-2 to indicate available of respective mobile wireless access points in the geographical region GR1. In addition to temporary available mobile wireless base stations in vehicles, based on a respective history of prior use of respective fixed wireless base stations supporting communications in a respective geographical region, the management entity 140 (management entity 140-1 and/or management entity 140-2) produces the tracking information 121-2 for time T2 or time duration TD2 to indicate the different wireless technologies supported by different fixed wireless networks and corresponding static wireless base stations that are stationary in the network environment 100.

Thus, whether fixed or mobile, the management entity 140 tracks which of the different possible wireless technologies and corresponding wireless networks are supported in each geographical region and stores such information in the tracking information 121-1 for time T1 or time duration TD1.

Further in this example embodiment, based on feedback from one or more entities and prior history of use by other vehicles and corresponding communication devices: i) the management entity 140 (i.e., management entity 140-1 and/or management entity 140-2) produces the tracking information 121-2 to indicate that geographical region GR1 supports wireless technology WT1 (such as via first type of wireless network, first wireless communication protocol, and first wireless connectivity type via one or more corresponding first wireless base stations); ii) the management entity 140 produces the tracking information 121-2 to indicate that geographical region GR1 supports wireless technology WT3 (such as via third type of wireless network, third wireless communication protocol, and third wireless connectivity type via corresponding one or more thirds wireless base stations); and so on. Wireless technologies WT2, WT5 are not supported in geographical region GR1. Wireless technology WT3 is not supported in geographical region GR2.

Accordingly, embodiments herein include: i) the management entity 140 or other suitable entity producing the tracking information 121-2 to indicate first geographical regions (GR1, GR2, GR3, GR4, GR5, GR6, etc.) supporting wireless technology WT1 supporting first wireless connectivity; ii) the management entity 140 or other suitable entity producing the tracking information 121-2 to indicate second geographical regions (GR2, GR3, GR5, GR6, etc.) supporting wireless technology WT2 supporting second wireless connectivity; iii) the management entity 140 or other suitable entity producing the tracking information 121-2 to indicate third geographical regions (GR1, GR4, etc.) supporting wireless technology WT3 supporting third wireless connectivity; iv) the management entity 140 or other suitable entity producing the tracking information 121-2 to indicate fourth geographical regions (GR1, GR2, GR3, GR4, GR5, GR6, GR7, etc.) supporting wireless technology WT4 supporting fourth wireless connectivity; v) the management entity 140 or other suitable entity producing the tracking information 121-2 to indicate fifth geographical regions (GR2, GR3, GR5, GR6, etc.) supporting wireless technology WT5 supporting fifth wireless connectivity; and so on.

Additionally, as previously discussed, the management entity 140 can be configured to track availability of different mobile wireless access points disposed in vehicles that reside in a respective geographical region. For example, assume that the mobile wireless access points support wireless communications in accordance with wireless technology WT7 and corresponding wireless communication protocol. The management entity 140 can be configured to receive first schedule information and/or location information indicating the time duration (TD2) in which the vehicle VEH2 and corresponding mobile communication device 112 will be present in the geographical region GR1; the management entity 140 can be configured to receive schedule information or feedback indicating that the vehicle VEH5 and corresponding mobile wireless access point 115 (a.k.a., mobile communication device) will be present in the geographical region GR2 to support wireless tethering of other mobile communication devices through the respective mobile wireless access point 115 to the remote network 190 during the time duration TD2; the management entity 140 can be configured to receive schedule information or feedback indicating that the vehicle VEH8 and corresponding mobile wireless access point 118 (a.k.a., mobile communication device) will be present in the geographical region GR2 to support wireless tethering of other mobile communication devices through the respective mobile wireless access point 118 of vehicle VEH8 to the remote network 190 during the time duration TD2; the management entity 140 can be configured to receive schedule information indicating that the vehicle VEH3 and corresponding mobile wireless access point 113 (a.k.a., mobile communication device) will be present in the geographical region GR3 to support wireless tethering of other mobile communication devices through the respective mobile wireless access point 113 of vehicle VEH3 to the remote network 190 during the time duration TD3; and so on.

As an alternative to receiving schedule information, the management entity 140 can be configured to receive notification from the one or more vehicles in the network environment of the availability of the different multiple wireless access points in the geographical regions at or around time T2 or in time duration TD2.

Assume that the mobile wireless access points support a wireless technology WT7 and corresponding wireless communication protocol. Note that the wireless technology WT7 alternatively may be any one of the multiple wireless technologies WT1, WT2, WT3, WT4, WT5, WT6, etc., (wireless technologies such as Satellite, 5G, 4G, LTE, Wi-Fi™, Zigbee™, LORAN™, LoranPWN, Bluetooth™, etc.) or a different wireless technology. In other words, each of the mobile wireless base stations as discussed herein can be configured to support any of the wireless technologies WT1, WT2, WT3, WT4, WT5, WT6, and/or WT7.

In such an instance, based on the received information, the management entity 140 produces the tracking information 121-2 for geographical region GR2 to indicate availability of wireless technology associated with multiple mobile wireless access points or mobile wireless base stations 115, 118, as well as static information indicating availability of fixed wireless technologies WT1, WT2, WT4, WT5, WT6, etc., and supporting connectivity to wireless networks N1, N2, N3, N4, N5, N6, and corresponding fixed wireless base stations to access remote network and communicate with management entity 140-2 (such as a management entity controlling operation of the vehicles VEH1, VEH2, VEH3, VEH4, VEH5, VEH6, VEH7, VEH8, VEH9, etc.).

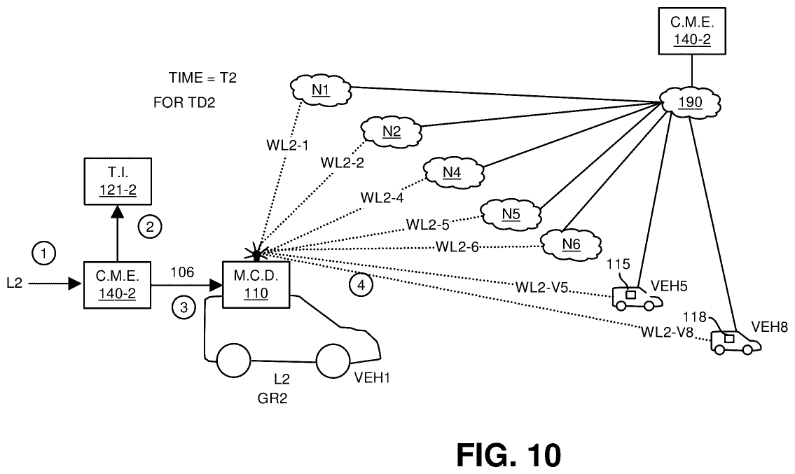

FIG. 10 is an example diagram illustrating detection of multiple different wireless networks in a network environment and testing of same to determine performance according to embodiments herein.

While in geographical region GR2 (location L2), in certain embodiments, vehicle VEH1 needs to communicate with the management entity 140-2 or management entity 140-1 to determine which wireless technologies may be available in geographical region GR2. As previously discussed, the mobile communication device 110 may initially communicate with the management entity 140-2 via a satellite communication link through network 190 or any of the possible wireless technologies as previously discussed.

Initially, in processing operation #1, the vehicle VEH1 determines its location and supplies its current location L2 (or anticipated future location L2) to management entity 140-1. The management entity 140 (such as management entity 140-1 and/or management entity 140-2) receives the location information L2 of vehicle VEH1 and determines that the vehicle VEH1 resides in or will soon reside in the geographical region GR2. As previously discussed, the management entity 140-2 may receive the location information L2 transmitted from the management entity 140-1 over a wireless satellite link (WL5) to the management entity 140-2.

As previously discussed, the tracking information 121-2 tracks availability of multiple different types of wireless technologies (and corresponding networks) available in each of the multiple geographical regions of network environment 100. In this example embodiment, via the tracking information 121-2, the management entity 140 determines multiple types of wireless technologies supported at the current location L2 and geographical region GR2 in which the first vehicle VEH1 and communication device 110 reside or will reside soon. As previously discussed, the tracking information 121-2 can be created from prior use of multiple types of wireless technologies discovered and used by multiple vehicles passing through the pathway 101 or scheduled presence of one or more mobile wireless access points in each of the different geographical regions.

Further in this example embodiment, in processing operation #2, the management entity 140 (such as management hardware, management software, or a combination of management hardware and management software) determines the different wireless technologies and corresponding networks supporting wireless access in geographical region GR2 via the tracking information 121-2 at or around time T2 such as during time duration TD2. For example, via the tracking information 121-2, the management entity 140 can be configured to determine that the wireless technology supported in geographical region GR2 (in which location L2 resides) includes wireless technology WT1, wireless technology WT2, wireless technology WT4, wireless technology WT5, wireless technology WT6, and wireless technology WT7.

More specifically, via mapping of the location L2 to geographical region GR2, and mapping of geographical region GR2 to different wireless technologies in tracking information 121-2, the management entity 140 produces input 105 indicating the different wireless technologies available in the geographical region GR2. Thus, the mobile communication device 110 receives input indicating the multiple types of wireless technologies supported at the current location L2 in which the vehicle VEH1 resides. This alleviates the mobile communication device 110 from having to discover by itself which of the wireless technologies are available for use in geographical region GR2.

In certain instances, the management entity 140-2 can be configured to perform a respective function such as require the mobile communication device 110 to establish 3 wireless communication links (instead of two) if a particular wireless technology such as wireless technology WT3 is not available in the corresponding geographical region GR2. Wireless technologies other than wireless technology WT3 may be less reliable. The increased number of wireless links when wireless technology WT3 and cog network N3 is not available ensures that the mobile communication device 110 is always able to communicate with the management entity 140-2 even if two of the wireless links happen to fail.

As previously discussed, the tracking information 121-1 can be configured to indicate which of the different available wireless technologies provide the best performance in the geographical region GR2. In such an instance, the input 106 indicates which of the different wireless technologies is potentially to be used by the mobile communication device 110 to establish respective multi-link wireless connectivity to the management entity 140-2. However, it is noted that performance of the respective wireless technologies and corresponding communication links may vary over time. In such an instance, it is desirable for the mobile communication device 110 to initiate a performance test to determine which of the candidate wireless technologies will provide best connectivity between the communication device 110 and the management entity 140-2 while in geographical region GR2.

To this end, in processing operation #4, the mobile communication device of vehicle VEH1 at location L2 in geographical region GR2 determines a performance of each of the multiple types of available wireless technologies WT1, WT2, WT4, WT5, WT6, and WT7 supported at the current location L2 by testing a performance of each of the respective wireless technologies WT1, WT2, WT4, WT5, WT6, and WT7. Testing the performance of each of the different types of available wireless technologies can include establishing a respective wireless link between the mobile communication device 110 (as the vehicle VEH1 is moving through the pathway 101 in network environment 100) and each of the different networks supporting the different wireless technologies.

For example, in one embodiment, the mobile communication device 110 establishes a respective wireless link associated with each of the available wireless technologies. The management entity 140-1 and/or communication device 110 tests each of the candidate wireless technologies to determine which of the multiple wireless technologies as specified by the tracking information 121-2 for geographical region GR2 are best for establishing at least triple wireless connectivity between the mobile communication device 110/management entity 140-1 in vehicle VEH1 and the management entity 140-2.

More specifically, for testing purposes, the communication device 110 establishes wireless link WL2-1 between the mobile communication device 110 and the first network N1 supporting the first wireless communication technology WT1 (wireless communication protocol #1); the mobile communication device 110 determines a respective performance (such as latency, bandwidth, etc.) of the wireless WL2-1 and wireless technology WT1 via a latency and/or bandwidth test. For example, the communication device 110 and/or network N1 can be configured to determine a latency and/or bandwidth supported between the mobile communication device 110 and the management entity 140-2. As further discussed herein, the management entity 140 produces performance information P1-1 to indicate the performance of wireless link WL2-1 and/or full path connectivity between the mobile communication device 110 and the management entity 140-2 including the wireless link WL2-1. In one embodiment, the performance information P1-1 indicates a latency associated with wireless technology WT1 between a time of communicating a message from the communication device 110 over the wireless communication link WL2-1 and network 190 and a time of the management entity 140-2 receiving the message. Round-trip times of messages between the mobile communication device 110 and the management entity 140-2 also can be used to determine performance associated with the wireless link WL2-1 and connection to the management entity 140-2 via wireless technology WT1. Least latency is desired.

For further testing purposes, the communication device 110 establishes wireless link WL2-2 between the mobile communication device 110 and the network N2 supporting the wireless communication technology WT2 (wireless communication protocol #2); the mobile communication device 110 determines a respective performance (such as latency, bandwidth, etc.) of the wireless WL2-2 via a latency and/or bandwidth test. For example, the communication device 110 and/or network N2 can be configured to determine a latency and/or bandwidth supported between the mobile communication device 110 and the management entity 140-2. The management entity 140 produces performance information P2-2 to indicate the performance of wireless link WL2-2 and/or full path connectivity between the mobile communication device 110 and the management entity 140-2 including the wireless link WL2-2. In one embodiment, the performance information P2-2 indicates a latency of wireless technology WT2 between a time of communicating a message from the communication device 110 over the wireless communication link WL2-2 and network 190 and a time of the management entity 140-2 receiving the message. Round-trip times of messages between the mobile communication device 110 and the management entity 140-2 also can be used to determine performance associated with the wireless link WL2-2 and connection to the management entity 140-2 via wireless technology WT2.

For testing purposes, the communication device 110 establishes wireless link WL2-4 between the mobile communication device 110 and the network N4 supporting the fourth wireless communication technology WT4 (wireless communication protocol #4); the mobile communication device 110 determines a respective performance (such as latency, bandwidth, etc.) of the wireless WL2-4 via a latency and/or bandwidth test. For example, the communication device 110 and/or network N4 can be configured to determine a latency and/or bandwidth supported between the mobile communication device 110 and the management entity 140-2. The management entity 140 produces performance information P2-4 to indicate the performance of wireless link WL2-4 and/or full path connectivity between the mobile communication device 110 and the management entity 140-2 including the wireless link WL2-4. In one embodiment, the performance information P2-4 indicates a latency between a time of communicating a message from the communication device 110 over the wireless communication link WL2-4 and network 190 and a time of the management entity 140-2 receiving the message. Round-trip times of messages between the mobile communication device 110 and the management entity 140-2 also can be used to determine performance associated with the wireless link WL2-4 and connection to the management entity 140-2 via wireless technology WT4.

For testing purposes, the communication device 110 establishes wireless link WL2-5 between the mobile communication device 110 and the network N5 supporting the wireless communication technology WT5 (wireless communication protocol #5); the mobile communication device 110 determines a respective performance (such as latency, bandwidth, etc.) of the wireless WL2-5 via a latency and/or bandwidth test. For example, the communication device 110 and/or network N5 can be configured to determine a latency and/or bandwidth supported between the mobile communication device 110 and the management entity 140-2. The management entity 140 produces performance information P2-5 to indicate the performance of wireless link WL2-5 and/or full path connectivity between the mobile communication device 110 and the management entity 140-2 including the wireless link WL2-5. In one embodiment, the performance information P2-5 indicates a latency between a time of communicating a message from the communication device 110 over the wireless communication link WL2-5 and network 190 and a time of the management entity 140-2 receiving the message. Round-trip times of messages between the mobile communication device 110 and the management entity 140-2 also can be used to determine performance associated with the wireless link

For testing purposes, the communication device 110 establishes wireless link WL2-6 between the mobile communication device 110 and the network N6 supporting the wireless communication technology WT6 (wireless communication protocol #6); the mobile communication device 110 determines a respective performance (such as latency, bandwidth, etc.) of the wireless WL2-6 via a latency and/or bandwidth test. For example, the communication device 110 and/or network N6 can be configured to determine a latency and/or bandwidth supported between the mobile communication device 110 and the management entity 140-2. The management entity 140 produces performance information P2-6 to indicate the performance of wireless link WL2-6 and/or full path connectivity between the mobile communication device 110 and the management entity 140-2 including the wireless link WL2-6. In one embodiment, the performance information P2-6 indicates a latency between a time of communicating a message from the communication device 110 over the wireless communication link WL2-6 and network 190 and a time of the management entity 140-2 receiving the message. Round-trip times of messages between the mobile communication device 110 and the management entity 140-2 also can be used to determine performance associated with the wireless link WL2-6 and connection to the management entity 140-2 via wireless technology WT6.

For testing purposes, the communication device 110 establishes wireless link WL2-V5 between the mobile communication device 110 and the mobile wireless access point in vehicle VEH5 supporting the wireless communication technology WT7 (wireless communication protocol #7 or other wireless communication protocol); the mobile communication device 110 determines a respective performance (such as latency, bandwidth, etc.) of the wireless WL2-V5 via a latency and/or bandwidth test. For example, the communication device 110 and/or management entity can be configured to determine a latency and/or bandwidth supported between the mobile communication device 110 and the management entity 140-2 (i.e., path including wireless communication link WL2-V5 through the mobile wireless access point 115 of vehicle VEH2 and network 190 to the management entity 140-2). The management entity 140 produces performance information P2-7-5 to indicate the performance of wireless link WL2-V5 and/or full path connectivity between the mobile communication device 110 and the management entity 140-2 including the wireless link WL2-V5. In one embodiment, the performance information P2-7-5 indicates a latency between a time of communicating a message from the communication device 110 over the wireless communication link WL2-V5 and network 190 and a time of the management entity 140-2 receiving the message. Round-trip times of messages between the mobile communication device 110 and the management entity 140-2 also can be used to determine performance associated with the wireless link WL2-V5 and connection to the management entity 140-2 via wireless technology WT7.

For testing purposes, the communication device 110 establishes wireless link WL2-V8 between the mobile communication device 110 and the mobile wireless access point in vehicle VEH8 supporting the wireless communication technology WT7 (wireless communication protocol #7 or other wireless communication protocol); the mobile communication device 110 determines a respective performance (such as latency, bandwidth, etc.) of the wireless WL2-V8 via a latency and/or bandwidth test. For example, the communication device 110 and/or management entity can be configured to determine a latency and/or bandwidth supported between the mobile communication device 110 and the management entity 140-2 (i.e., path including wireless communication link WL2-V8 through the mobile wireless access point of vehicle VEH8 and network 190 to the management entity 140-2). The management entity 140 produces performance information P2-7-8 to indicate the performance of wireless link WL2-V8 and/or full path connectivity between the mobile communication device 110 and the management entity 140-2 including the wireless link WL2-V8. In one embodiment, the performance information P2-7-8 indicates a latency between a time of communicating a message from the communication device 110 over the wireless communication link WL2-V8 and network 190 and a time of the management entity 140-2 receiving the message. Round-trip times of messages between the mobile communication device 110 and the management entity 140-2 also can be used to determine performance associated with the wireless link WL2-V8 and connection to the management entity 140-2 via wireless technology WT7.

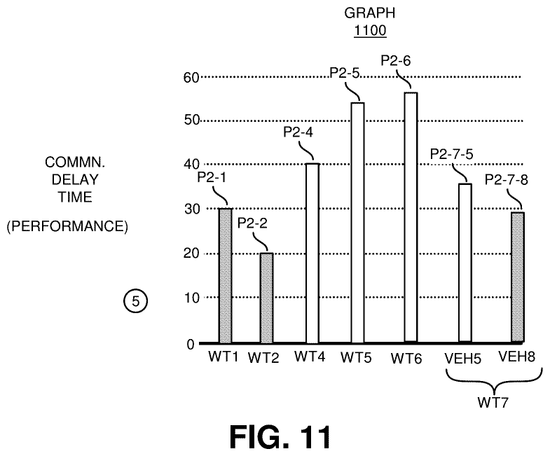

An example of the generated performance information P2-1, P2-2, P2-4, P2-5, P2-6, P2-7-5, P2-7-8 is shown in FIG. 11.

FIG. 11 is an example diagram illustrating generation and comparison of performance information for each of multiple available wireless networks in a given geographical region according to embodiments herein.

Based on the performance information, in processing operation #5, the management entity 140-2, the communication device 110, and/or management entity 140-1 in the first vehicle VEH1 determines which of the multiple available wireless technologies (such as best 3) and corresponding wireless technologies supports the best performance (such as lowest latency communication paths between the communication device 110 and the management entity 140-2).

More specifically, in this embodiment, the communication device 110 and/or management entity 140-1 selects amongst the multiple types of wireless technologies to establish wireless connectivity between the vehicle VEH1 and the remote network 190. For example, the wireless technology WT2 and corresponding wireless network N2 provide performance P2-2 and therefore the best performance such as lowest latency. The wireless technology WT1 and corresponding wireless network N1 provide performance P2-1 and there the next best performance such as next lowest latency. The wireless technology WT8 and corresponding wireless network N8 provide performance P2-7-8 and there the next best performance such as next lowest latency.

Accordingly, the three wireless technologies such as wireless technology WT1 (network N1, performance information P2-1), wireless technology WT2 (network N2, performance information P2-2), and wireless technology WT7 (mobile wireless base station 118, performance information P2-7-8), are chosen to provide simultaneous wireless connectivity between the mobile communication device and the management entity 140-2. As previously discussed, in one embodiment, the management entity 140 and/or mobile communication device 110 select three wireless links instead of 2 in response to detecting that wireless technology WT3 (such as 5G) is not supported in the geographical region GR2.

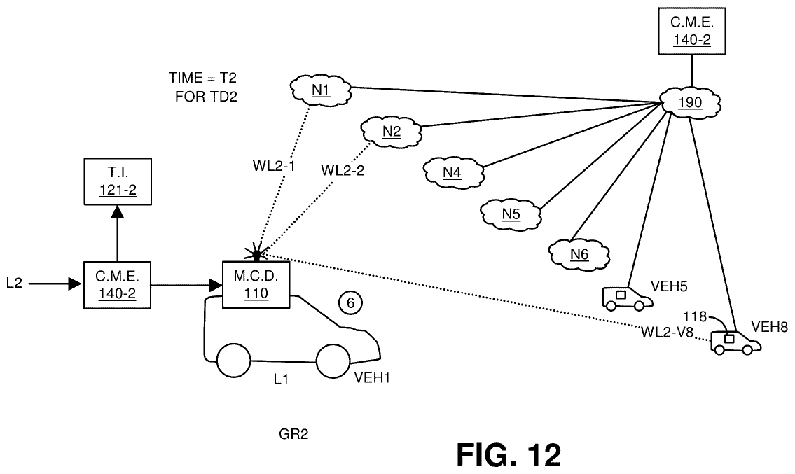

FIG. 12 is an example diagram illustrating selection of multiple wireless networks and simultaneous use of the selected wireless networks to communicate with a remote communication management entity according to embodiments herein.

As previously discussed, from the multiple types of wireless technologies WT1, WT2, WT4, WT5, WT6, and WT7 supported at the current location L2 in the geographical region GR2, the mobile communication device 140-1 selects the wireless technology WT1 to support a first wireless communication link WL2-2 (wireless network N2) between the vehicle VEH1 and the remote network 190 to communicate with the management entity 140-2 (controller). From the multiple types of wireless technologies supported at the current location L2 in the geographical region GR2, the mobile communication device 140-1 also selects the wireless technology WT2 to support wireless communication link WL2-4 (wireless network N4) between the vehicle VEH1 and the remote network 190 to communicate with the management entity 140-2 (controller). The mobile communication device 110 and/or management entity 140-1 also selects the wireless technology WT7 to support wireless communication link WL2-V8 (mobile wireless base station 118) between the vehicle VEH1 and the remote network 190 to communicate with the management entity 140-2 (controller).

In one embodiment, in processing operation #6, the wireless communication link WL2-1, the wireless communication link WL2-2, and wireless communication link WL2-V8 are simultaneously implemented/used by the communication device 110 in the vehicle VEH1 to support redundant wireless connectivity between the vehicle VEH1 and the remote network 190. The redundancy ensures that the mobile communication device 110 is able to communicate with the remote controller (management entity 140-2) to provide feedback information (odometer information, speed, vehicle maintenance/diagnostic information, poor road conditions such as ice, temperature, etc.) as previously discussed as well as receive control information from the management entity 140-2 even if two of the wireless links (WL2-1 or WL2-2 or WL2-V8) happens to fail while the vehicle VEH1 is in the geographical region GR2.

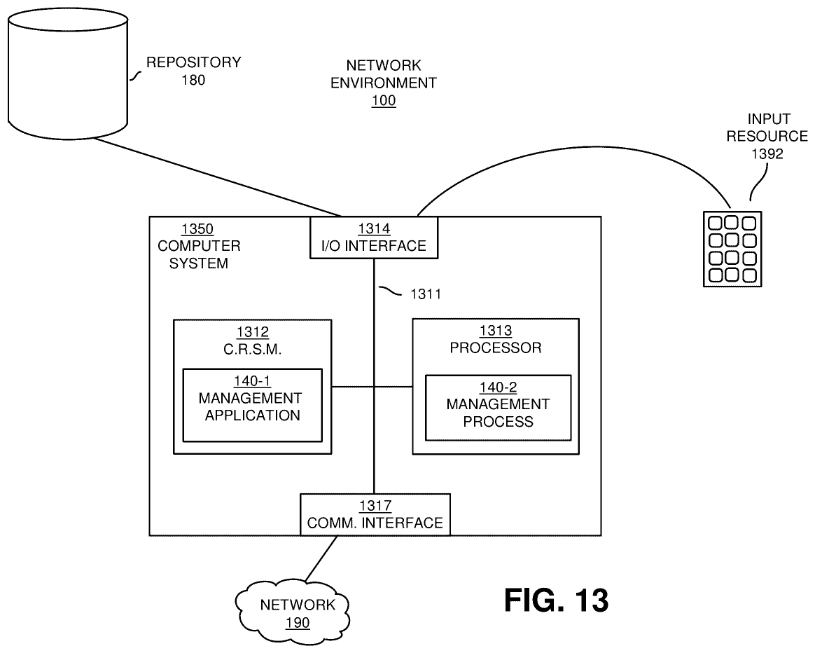

FIG. 13 is an example block diagram of a computer system for implementing any of the operations as previously discussed according to embodiments herein.

Note that any of the resources as discussed herein can be configured to include computer processor hardware and/or corresponding executable instructions to carry out the different operations as discussed herein.

For example, as shown, computer system 1350 of the present example includes interconnect 1311 coupling computer readable storage media 1312 such as a non-transitory type of media (which can be any suitable type of hardware storage medium in which digital information can be stored and or retrieved), a processor 1313 (computer processor hardware), I/O interface 1314, and a communications interface 1317.

I/O interface(s) 1314 supports connectivity to repository 1380 and input resource 1392.

Computer readable storage medium 1312 can be any hardware storage device such as memory, optical storage, hard drive, floppy disk, etc. In one embodiment, the computer readable storage medium 1312 stores instructions and/or data.

As shown, computer readable storage media 1312 can be encoded with management application 140-A (e.g., including instructions associated with any entity as discussed herein) in a respective wireless station to carry out any of the operations as discussed herein.

During operation of one embodiment, processor 1313 accesses computer readable storage media 1312 via the use of interconnect 1311 in order to launch, run, execute, interpret or otherwise perform the instructions in management application 140-A stored on computer readable storage medium 1312. Execution of the management application 140-A produces management process 140-B to carry out any of the operations and/or processes as discussed herein.

Those skilled in the art will understand that the computer system 1350 can include other processes and/or software and hardware components, such as an operating system that controls allocation and use of hardware resources to execute the management application 140-A.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1350 may reside at any location or can be included in any suitable resource in any network environment to implement functionality as discussed herein.

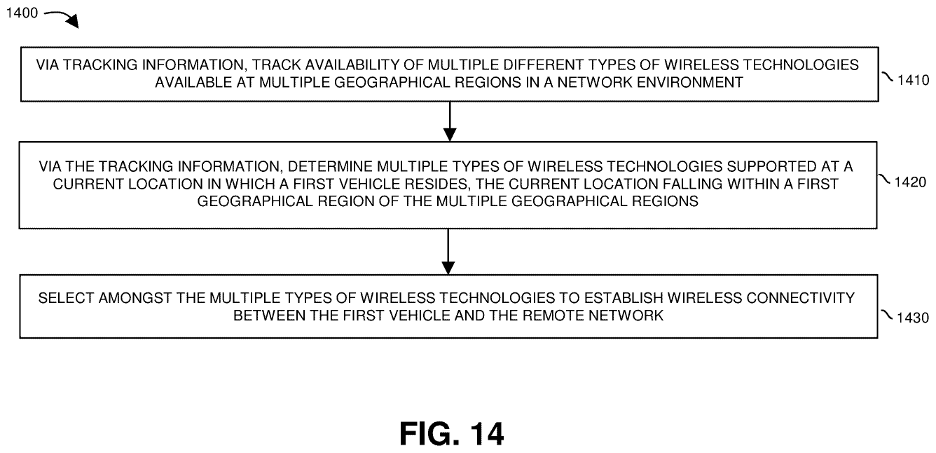

Functionality supported by the different resources will now be discussed via flowcharts in FIG. 14. Note that the steps in the flowcharts below can be executed in any suitable order.

FIG. 14 is a flowchart 1400 illustrating an example method according to embodiments herein. Note that there will be some overlap with respect to concepts as discussed above.

In processing operation 1410, via tracking information 121, the communication management resource (i.e., management entity 140) tracks availability of multiple different types of wireless technologies available at multiple geographical regions in a network environment 100.

In processing operation 1420, via the tracking information 121, the communication management resource determines multiple types of wireless technologies supported at a current location (current geographical region) in which a first vehicle VEH1 resides; the current location falling within the first geographical region of the multiple geographical regions.

In processing operation 1430, the communication management resource 140 selects amongst the multiple types of wireless technologies to establish wireless connectivity between the first vehicle VEH1 and the remote network 190 and management entity 140-2.

Note again that techniques herein are well suited to facilitate wireless connectivity in accordance with different available wireless services. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
via tracking information, tracking availability of multiple different types of wireless technologies available at multiple geographical regions in a network environment;
via the tracking information, determining multiple types of wireless technologies supported at a current location in which a first vehicle resides, the current location falling within a first geographical region of the multiple geographical regions; and
selecting amongst the multiple types of wireless technologies to establish wireless connectivity between the first vehicle and the remote network.

2. The method as in claim 1, wherein the tracking information indicates prior use of the multiple types of wireless technologies by multiple vehicles other than the first vehicle.

3. The method as in claim 1 further comprising:
based on a performance analysis implemented by a communication device in the first vehicle, determining a performance of the multiple types of wireless technologies supported at the current location.

4. The method as in claim 1, wherein tracking availability of the multiple types of wireless technologies at the different geographical regions in the network environment via the tracking information includes:
receiving feedback from multiple vehicles other than the first vehicle traveling through the different geographical regions in the network environment, the feedback indicating the availability of the multiple wireless technologies at the different geographical regions in the network environment.

5. The method as in claim 1, wherein the multiple types of wireless technologies include:
a first wireless technology supporting wireless connectivity in accordance with a first wireless communication protocol;
a second wireless technology supporting wireless connectivity in accordance with a second wireless communication protocol; and
a third wireless technology supporting wireless connectivity in accordance with a third wireless communication protocol.

6. The method as in claim 1, wherein selecting amongst the multiple types of wireless technologies to establish connectivity between the first vehicle and the remote network includes:
from the multiple types of wireless technologies supported at the current location, selecting a first wireless technology to support a first wireless communication link between the first vehicle and a first wireless access point providing first access to the remote network; and
from the multiple types of wireless technologies supported at the current location, selecting a second wireless technology to support a second wireless communication link between the first vehicle and a second wireless access point providing second access to the remote network.

7. The method as in claim 6, wherein the first wireless communication link and the second wireless communication link are simultaneously implemented by a communication device in the first vehicle to support redundant wireless connectivity between the first vehicle and the remote network.

8. The method as in claim 1, wherein determining the multiple types of wireless technologies includes:
receiving input from a management entity associated with the first vehicle, the input indicating the multiple types of wireless technologies supported at the current location in which the first vehicle resides.

9. The method as in claim 8, wherein selecting amongst the multiple types of wireless technologies to establish connectivity between the first vehicle and the remote network includes:
determining a respective wireless performance associated with each of the multiple types of wireless technologies.

10. The method as in claim 1, wherein the first vehicle is one of multiple vehicles traveling through the network environment; and
wherein selecting amongst the multiple types of wireless technologies to establish the wireless connectivity between the first vehicle and the remote network includes: establishing wireless connectivity with a mobile wireless access point in a second vehicle notification, the wireless connectivity supporting communication through the mobile wireless access point of the second vehicle to the remote network.

11. A system comprising:
management hardware operative to
via tracking information, tracking availability of multiple different types of wireless technologies available at multiple geographical regions in a network environment;
via the tracking information, determine multiple types of wireless technologies supported at a current location in which a first vehicle resides, the current location falling within a first geographical region of the multiple geographical regions; and
select amongst the multiple types of wireless technologies to establish wireless connectivity between the first vehicle and the remote network.

12. The system as in claim 11, wherein the tracking information indicates prior use of the multiple types of wireless technologies by multiple vehicles other than the first vehicle.

13. The system as in claim 11, wherein the management hardware is further operative to:
determine a performance of the multiple types of wireless technologies supported at the current location based on a performance analysis of wireless communications between the communication device in the first vehicle and multiple wireless networks supporting the multiple types of wireless technologies.

14. The system as in claim 11, wherein the management hardware is further operative to:
receive feedback from multiple vehicles other than the first vehicle traveling through the different geographical regions in the network environment, the feedback indicating the availability of the multiple wireless technologies at the different geographical regions in the network environment.

15. The system as in claim 11, wherein the multiple types of wireless technologies include:
a first wireless technology supporting wireless connectivity in accordance with a first wireless communication protocol;
a second wireless technology supporting wireless connectivity in accordance with a second wireless communication protocol; and
a third wireless technology supporting wireless connectivity in accordance with a third wireless communication protocol.

16. The system as in claim 11, wherein the management hardware is further operative to:
from the multiple types of wireless technologies supported at the current location, select a first wireless technology to support a first wireless communication link between the first vehicle and a first wireless access point providing first access to the remote network; and
from the multiple types of wireless technologies supported at the current location, select a second wireless technology to support a second wireless communication link between the first vehicle and a second wireless access point providing second access to the remote network.

17. The system as in claim 16, wherein the first wireless communication link and the second wireless communication link are simultaneously implemented by a communication device in the first vehicle to support redundant wireless connectivity between the first vehicle and the remote network.

18. The system as in claim 11, wherein the management hardware is further operative to:
receive input indicating the multiple types of wireless technologies supported at the current location in which the vehicle resides.

19. The system as in claim 11, wherein the management hardware is further operative to:
determining a respective wireless performance associated with each of the multiple types of wireless technologies.

20. The system as in claim 11, wherein the first vehicle is one of multiple vehicles traveling through the network environment; and
wherein the management hardware is further operative to provide notification to the first vehicle to establish a wireless communication link through a second vehicle to the remote network.

21. Computer-readable storage hardware having instructions stored thereon, the instructions, when carried out by computer processor hardware, cause the computer processor hardware to:
via tracking information, track availability of multiple different types of wireless technologies available at multiple geographical regions in a network environment;
via the tracking information, determine multiple types of wireless technologies supported at a current location in which a first vehicle resides, the current location falling within a first geographical region of the multiple geographical regions; and
select amongst the multiple types of wireless technologies to establish wireless connectivity between the first vehicle and the remote network.
